(19) United States
(12) Patent Application Publication
(10) Pub. No.: US 2015/0221004 A1
(43) Pub. Date: Aug. 6, 2015

(54) BUYING TIME VIA TIME SLOTS

(71) Applicant: BUIITIME LLC, Westlake, OH (US)

(72) Inventor: Barry Pavlo, Westlake, OH (US)

(73) Assignee: BUIITIME LLC, Westlake, OH (US)

(21) Appl. No.: 14/295,250

(22) Filed: Jun. 3, 2014

Related U.S. Application Data
(60) Provisional application No. 61/935,750, filed on Feb. 4, 2014.

(51) Int. Cl. G06Q 30/06; G06Q 50/18

(52) U.S. Cl. CPC G06Q 30/06; G06Q 50/188

(57) ABSTRACT

Time slot marketplace management is described. A method includes receiving a request from a first entity to initiate an event between a first entity and a second entity, the request that includes a time to conduct the event and a proposed consideration. The method further includes providing, to the second entity, an identity of the first entity, the time and the proposed consideration. The method includes creating the event between the first entity and the second entity upon receiving an acceptance of the time and proposed consideration. The method includes receiving feedback from the second entity pertaining to the event after the event. In exchange for the proposed consideration, the second entity is required to provide the feedback related to the event. The method includes authorizing the consideration to be transferred to the second entity in response to receiving the feedback from the second entity.

### RELATED APPLICATION

This application claims the benefit of U.S. Provisional Application No. 61/935,750, filed Feb. 4, 2014, the entire contents of which are incorporated herein by reference.

### TECHNICAL FIELD

Embodiments of the present disclosure relate to time slot marketplace management.

### BACKGROUND

Increasingly, individuals are using computers and technology to accomplish more tasks in shorter amounts of time. Specifically, individuals can create and maintain electronic address books, share online documents and calendars, and collaborate with other individuals. In some instances, a requesting individual may desire to meet with another individual for various purposes, such as to pitch an opportunity, collaborate on a project, professional networking, and the like. Often, however, the individual who is being sought may place a high value on their time and thus, they may not be willing to meet with the requesting individual without being compensated for their time. Thus, conventionally, a requesting individual may find it difficult to meet with other individuals.

### BRIEF DESCRIPTION OF THE DRAWINGS

The present disclosure is illustrated by way of example, and not by way of limitation, in the figures of the accompanying drawings.

FIG. 1 illustrates one embodiment of a time slot manager, in accordance with one embodiment of the disclosure.

FIG. 2 illustrates an example diagram illustrating a buyer dashboard, according to some embodiments of the disclosure.

FIG. 3 illustrates one embodiment of an interface for creating a time slot event offer, according to some embodiments of the disclosure.

FIG. 4 is a flow diagram illustrating a method for managing time slot transactions, according to some embodiments of the disclosure.

FIG. 5 is a flow diagram illustrating a method for buying time slot transactions, according to some embodiments of the disclosure.

FIG. 6 is a flow diagram illustrating a method for selling time slot transactions, according to some embodiments of the disclosure.

FIG. 7 illustrates an example screenshot illustrating a seller dashboard, according to some embodiments of the disclosure.

FIG. 8 is a block diagram illustrating an example computer system, according to some embodiments of the disclosure.

### DETAILED DESCRIPTION

Described herein are methods and systems for time slot marketplace management. The systems and methods provide a marketplace for transactions of time slots. As used herein, a “time slot” refers to a quantity of time. For example, a time slot may be a 15 minute period of time. A time slot may refer to a fixed period of time, or alternatively, the time slot may be a variable period of time. The system allows a single user, or a group of users, to offer, create, market, and buy a time slot, and also to solicit feedback related to the activities that occurred through the transaction of the time slot. The system also allows a user to solicit for or sell a time slot, and provide feedback related to the activities that occurred through the transaction of the time slot.

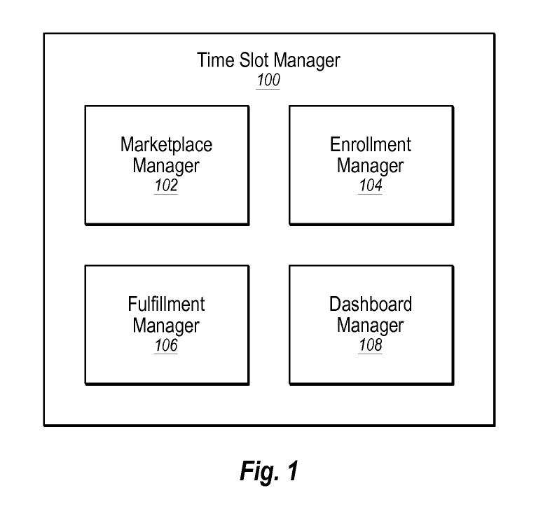

FIG. 1 illustrates one embodiment of a time slot manager 100. The time slot manager 100 includes a marketplace manager 102, an enrollment manager 104, a fulfillment manager 106, and a dashboard manager 108. The time slot manager 100 manages single and multi-user enrollment, customized email, the creation and tracking of time slots via customized dashboards, feedback form reporting, and the settlement of payments between buyers and sellers.

The marketplace manager 102 provides a virtual environment for transactions between prospective buyers and sellers for time slots. For example, the marketplace manager 102 delivers the value proposition for the time slot manager 100 to inform a prospective subscriber about time slot transactions and allow the prospective user to test time slot management. The market place manager 102 is simple, easy and intuitive to navigate, visually pleasing, informative, safe and secure, and quick to load and operate. In some embodiments, the marketplace manager 102 provides an internet-based or a web-based virtual environment that buyers and sellers can access from any device.

The enrollment manager 104 provides seamless account enrollment processes, for prospective users who desire to subscribe to and use the time slot manager, that include: an application process that captures key user demographic and payment information; account maintenance via a computing device such as a server; a group enrollment process (e.g., the enrollment manager can receive information about multiple users); an account maintenance process; and subscription maintenance and renewal processes.

Examples of subscriber information, for both single users and group subscribers, collected by the enrollment manager, during an enrollment event, include but are not limited to:

### Enrollment (Buyer and Seller)

First name
Last name

### Street

### City

### State/Province

### Zip

### Country

Primary telephone #

### Telephone ext.

Email address

### User ID

Answer to specific ID question

### Over 18—(Answer yes or no)

### Agreed to User Agreement and Privacy Policy

### Company Name

### Company Logo

### Personal Photo

### Payment (Buyer)

Payment method—mark credit card

### First

### Middle

### Last

### Card Number

### Security Code

### Expiration

### Receipt (Seller)

### Receipt Method—ACH, Check

### Account Name

### Account Type

Routing # (9 digit ABA)

### Acct #

### BT Account #

The fulfillment manager 106 manages communication between parties in a time slot transaction, including, incorporating email-like features and logic of an internet-based or web-based communication between two parties. The fulfillment manager 106 is also configured to manage communications involving an on-line mailbox, calendar, and document tracking facility (i.e., for uploading and tracking documents). For example, the fulfillment manager 106 may include add-an or stand-alone applications with an ability to incorporate time slot information into Outlook, Lotus Notes, CRMs and other desktop or mobile applications that have calendar tools. In some embodiments, the fulfillment manager 106 can be configured to manage communications in a web-based environment that users can logon to and manage activities related to time slots. In an example, the fulfillment manager provides a meeting invitation to a seller.

The fulfillment manager 106 is also configured to present a feedback form (e.g., a survey) to the buyer/seller. The fulfillment manager 106 allows a buyer and/or seller to select, build, save and send a brief customized feedback form to another subscriber of the marketplace, which includes auto-fill and event trigger applications. The fulfillment manager 106 can provide the feedback form to a time-slot seller. The fulfillment manager 106 can also receive a response related to the feedback form (e.g., at least one response to a question in a survey). Furthermore, the fulfillment manager 106 can be configured to cross-tabulate results from multiple feedback forms and provide reports across single, and groups of, sellers and buyers.

The fulfillment manager 106 is further configured to accept payments/settlements and other forms of payment (e.g., trade one time slot for another time slot). The fulfillment manager 106 also provides front-end subscriber payment via credit card, back-end settlement via ACH, check and other forms of settlement. In another embodiment, the fulfillment manager 106 also issues payments triggered by events, i.e., occurrence of a time slot event (e.g., a meeting) and the completion of a feedback form.

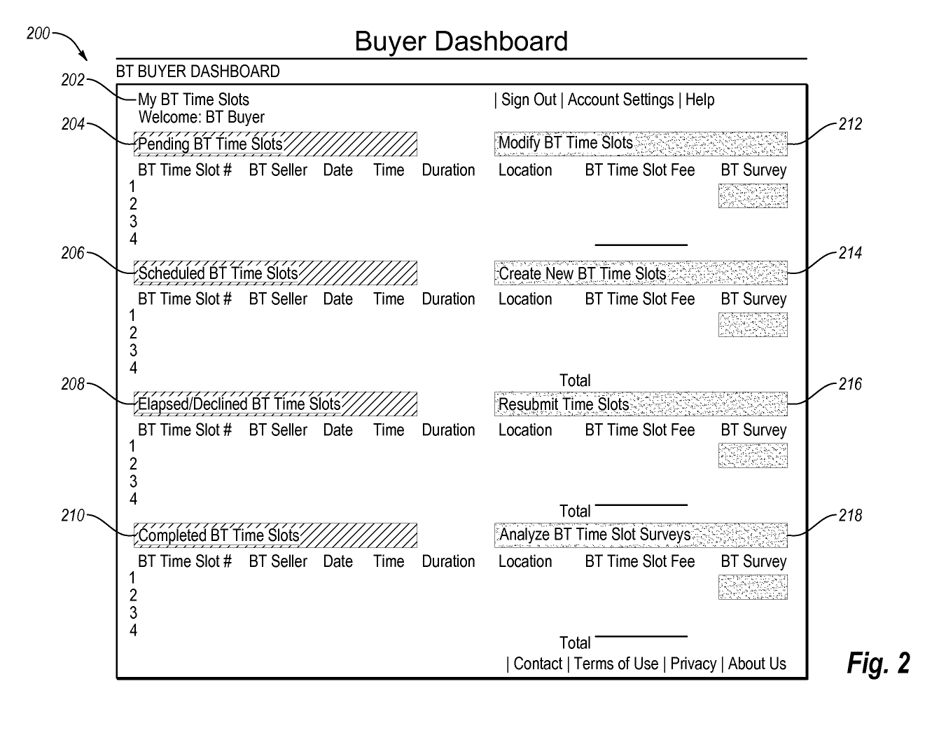

The dashboard manager 108 is configured to retrieve buyer and/or seller information from the enrollment manager, and time slot transaction information from the fulfillment manager 106 to create a customized dashboard. An example of a customized dashboard is described below with reference to FIG. 2.

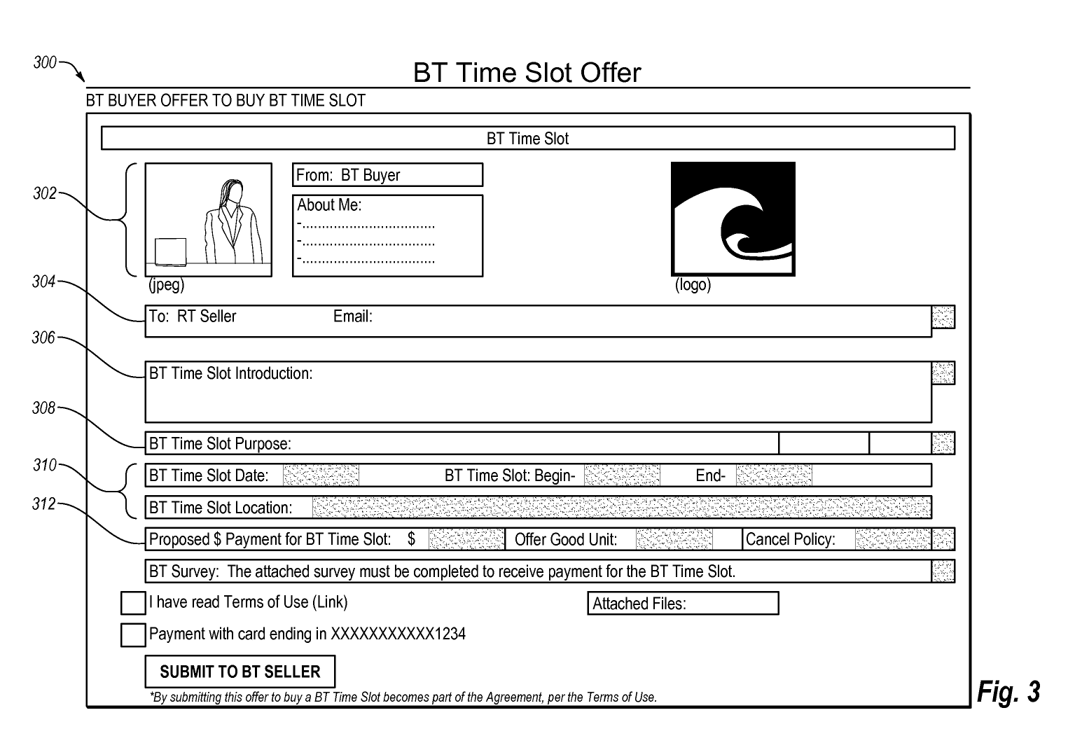

FIGS. 2-3 illustrate example graphical user interfaces (GUI) in accordance with aspects of the present disclosure. The example GUIs may be presented by and/or displayed within a web browser when the user accesses a time slot manager via the web browser. In another embodiment, the example GUIs may be an interface presented by a media viewer (e.g., an app, an application, a program, a software module/component, etc., that may be used for time slot marketplace management). Some example GUIs include control elements in the form of a button (e.g., a button for creating a time slot event). However, it should be noted that various other control elements can be used for selection by a user such as a check box, a link, or any other user interface elements.

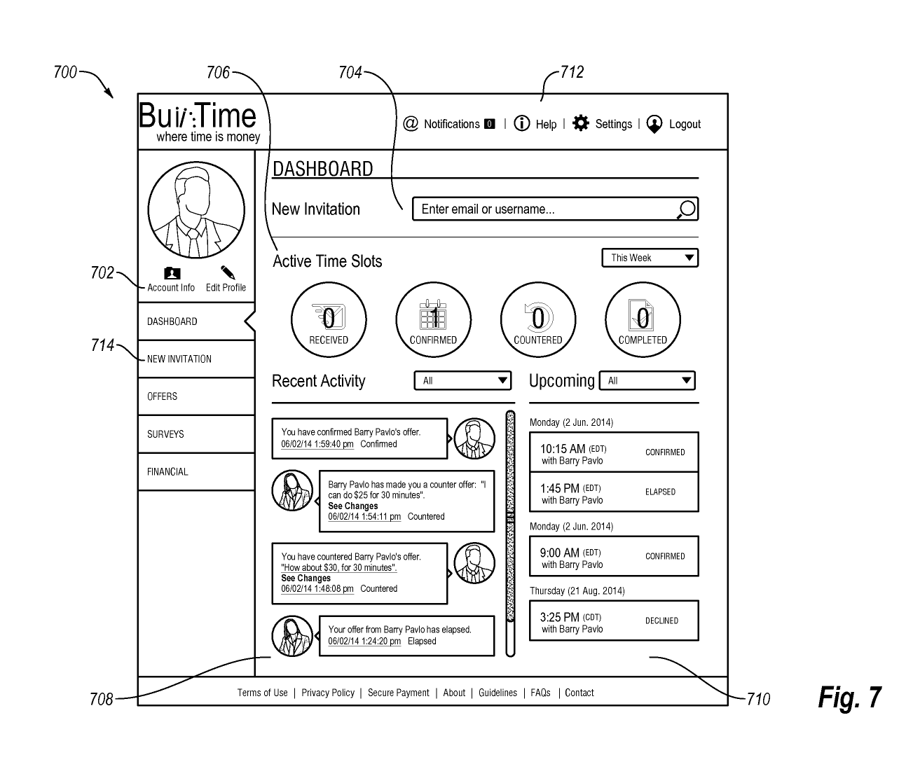

FIG. 2 illustrates one embodiment of a buyer dashboard 200, which may be generated by the dashboard manager 108 of FIG. 1. The depicted buyer dashboard, 200 as customized by the dashboard manager 108, includes information related to time slots offered to be purchased The dashboard manager is also configured to generate a seller dashboard, as further described in conjunction with FIG. 7. Examples of information to be presented or requested from a buyer/seller include, but are not limited to:

### Buyer Dashboard

### Confirmed Time Slot

### Name of Seller

Name of Seller company

### Time Slot Date

### Time Slot Time

### Time Slot Location

### Time Slot Confirmed Rate

Time Slot Total Cost—Rate+fees charged to use the Time Slot Manager
Time Slot Copy of feedback form used
Feedback form completed—y or n
Feedback tabulated—y or n

The buyer dashboard 200 may include user information 202 to identify the user (e.g., the buyer) that is currently logged in and has access to the buyer dashboard 200. In some embodiments, a user (e.g., buyer) can provide input via the buyer dashboard 200 to manage time slot events. For example, a buyer may view pending time slot events 204 (e.g., events that have not yet been accepted by the seller), scheduled time slot events 206, elapsed and/or declined time slot events 208 and completed time slot events 210. In some embodiments, the user can activate (e.g., click) on an entry in any of the above areas of the dashboard 200 to obtain more information related to the corresponding time slot event.

The dashboard 200 can also include other various time slot event management tools. In some embodiments, the dashboard 200 can provide the user with an option to modify a time slot event 212 (e.g., the user can modify sent, confirmed, countered, elapsed or declined time slot events). In some embodiments, the dashboard 200 can also include a mechanism 214 to initiate creation of new time slot events. In implementations, when a user actives the create new time slot event mechanism 214, a new GUI for creating a time slot event can be presented to the user. An example of the new GUI for creating a time slot event is described in further detail on conjunction with FIG. 3. In some embodiments, the dashboard 200 can include a mechanism for resubmitting time slot events 216. For example, a user (e.g., buyer) can resubmit a time slot event to the same seller or to another seller. In some embodiments, the dashboard 200 can include a mechanism 218 for accessing and analyzing time slot events and/or related feedback forms (e.g., surveys). In some embodiments, by activating the analyze time slot event mechanism, the user can be presented with a response to the feedback form from the seller. For example, a buyer may activate an “analyze feedback forms” mechanism 218 (e.g., a GUI button). By activating mechanism 218, the dashboard 200 can permit a buyer to view feedback forms, download feedback forms, generate reports based on one or more feedback form, etc.)

FIG. 3 illustrates one embodiment of an interface 300 for creating a time slot event offer. In some embodiments, the fulfillment manager 106 of FIG. 1 is configured to receive input for the time slot event from a buyer via interface 300, send a time slot offer from the buyer and communicate the time slot offer with a time slot seller (e.g., as a message). The interface 300 can include buyer information 302 that identifies the buyer, which can include the buyer's name, email address, phone number, and the like. In some embodiments, the buyer information 302 may include detailed “about me” information, and may also include a logo, avatar, icon, picture, image, portrait, etc. In some embodiments, the buyer provides the buyer information 302 for each time slot event offer. In some embodiments, the buyer information 302 is prefilled, and may include information related to the buyer that the buyer has previously provided to a time slot manager. In some embodiments, the prefilled buyer information 302 is editable.

The interface 300 provides one or more graphical interface tools that permit a buyer to create a time slot event offer. The graphical interface tools can include seller information 304, which may include an identity of the seller (e.g., name, email address, account identifier, phone number). The graphical interface tools can also include time slot event introduction information 306, which can describe the time slot event. The interface can provide pre-populated introductions, or the buyer can provide the time slot event introduction information 306. For example, when the time slot event is proposed by a salesperson (buyer) for a product pitch meeting with a procurement manager (seller), the salesperson may include information about the product, why the procurement manager would be interested, etc. in the time slot event introduction information 306. In some embodiments, the graphical interface tools include a time slot event tool 308, which the buyer may use to provide a quick summary of the proposed time slot event (e.g., product pitch). The graphical interface tools can also include time information 310 pertaining to a proposed time (or group of times) for the time slot event. In some embodiments, the graphical interface tools an upload attachment tool that permits a user (e.g., buyer) to upload an attachment (e.g., a file) that may be provided to another user (e.g., seller) at any time, such as before the time slot event (e.g., as part of a time slot offer). The attachment may be a document to be discussed between the buyer and seller during the time slot event. For example, a salesperson can attach a presentation document to be discussed during the time slot event. In some embodiments, the attachment is uploaded from a user device to a server.

The graphical interface tools can also include a consideration tool 312 for the buyer to input a proposed consideration (e.g., payment) that is to be provided to the seller upon completion of the time slot event and/or upon the buyer's receipt of a feedback form related to a completed time slot event from the seller. In some embodiments, in exchange for the proposed consideration, the seller is required to provide feedback related to the time slot event via the feedback form. The consideration may take any form, including money, in-kind payments, goods, services, etc.

The interface 300 may also include a financial area (not shown). The financial area may be used to present any type of financial information. The financial area may be presented in association with a user, such as on a user profile page, in a time slot offer, as part of a counter proposal, etc. For example, the financial area may include an average amount that a particular buyer has paid for past time slot events or a minimum amount a seller is willing to sell a time slot event. This may be helpful to the buyer when determining a price for a proposed time slot event. Similarly, the financial section may be helpful for a seller, as it may present to the buyer (e.g., on the seller's profile, in a counter offer) an amount that the seller has received for past time slot events. In this manner, the financial section may help a user (buyer or seller) attract an amount of money they have either paid (buyer) or sold (seller) by time period, month, year, since inception, etc. In some embodiments, when a time slot event is between one individual and a group of individuals (or between a first group of individuals and a second group of individuals), the financial information may include information that places limits on a payment (either individually or as a group). For example, a buyer that is part of a buyer group may only desire to contribute a certain amount or a percentage of the total time slot fee. The financial information may be used to indicate such. Other information received and/or presented in interface 300 by the fulfillment manager 106 can include, but is not limited to:

### Time Slot Information—Buyer

Unique id for each Time Slot (generated)
Seller email address

### Name of Seller

Company name of Seller
Date sent
Time sent
Proposed Time Slot date
Proposed Time Slot time

### Length of Time Slot

### Location of Time Slot

### Time Slot Fee

### Feedback Form

Contents of Time Slot email

### Attachments to Time Slot

### Time Slot—Seller

Unique id for each Time Slot
Buyer email address

### Financial—Buyer and Seller

### Payments

Previous amount paid
Previous amount collected
Group limits

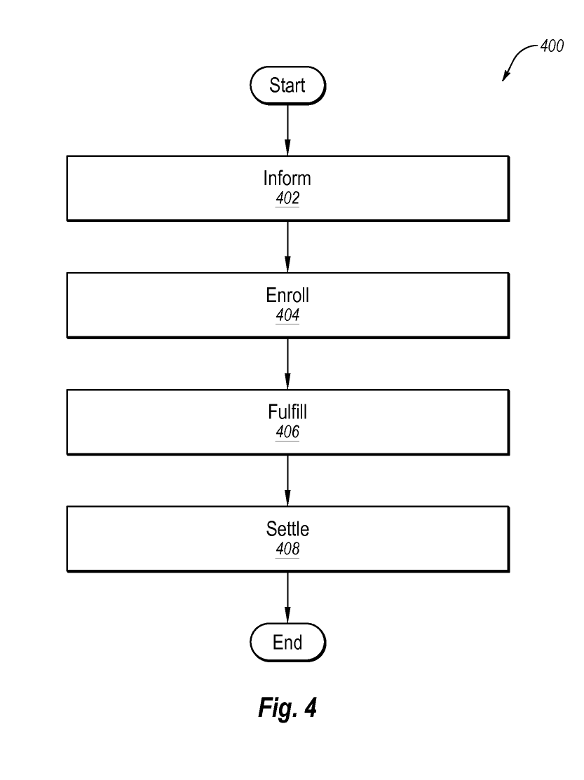

FIG. 4 is a flow diagram of one embodiment of a method 400 of managing time slot transactions. The method 400 is performed by processing logic that may comprise hardware (circuitry, dedicated logic, etc.), software (such as is run on a general-purpose computing system or a dedicated machine), or a combination of both. In one embodiment, the time slot manager 100 of FIG. 1 performs the method 400.

The method 400 starts and the processing logic, at block 402 informs potential subscribers about the time slot marketplace. For example, the processing logic may present an introduction to the buying/selling of time concept, and an accompanying feedback form (e.g., survey). The processing logic may also provide information that conveys how the marketplace incorporates elements of direct negotiation via email functionality, offering and selling of time slots, on-line feedback forms, surveys and analysis, and efficient settlement of payments via credit card, ACH, etc.

At block 404, the processing logic enrolls potential subscribers/users. In one embodiment, the processing logic receives account applications, reviews the applications, and accepts or rejects the application. The determination of whether to accept or reject a potential subscriber may be based on, but not limited to, agreeing to the terms of use for the time slot manager 100, meeting a minimum age requirement, predetermined parameters for both a maximum and minimum amount to be paid for a time slot, type of business user is employed in, employer consent, regulatory jurisdiction, among others.

At block 406, the processing logic fulfills a time slot transaction. In one embodiment, the processing logic fulfills time slot transactions by scheduling meetings, call or other events between buyers and sellers, managing correspondence, logistics (time value), etc. The processing logic also maintains counter offers related to the offer and purchase of a time slot, whereby the initial offer by one subscriber may not be accepted, and a counter offer is proposed by the subscriber receiving the initial offer. The counter offer cycle may continue between subscribers until an offer is agreed upon by both entities. The processing logic also confirms completions of the transactions with at least one feedback form. At block 408, the processing logic settles the transaction by verifying the completion of the one or more feedback form and processing payments between the buyer and seller.

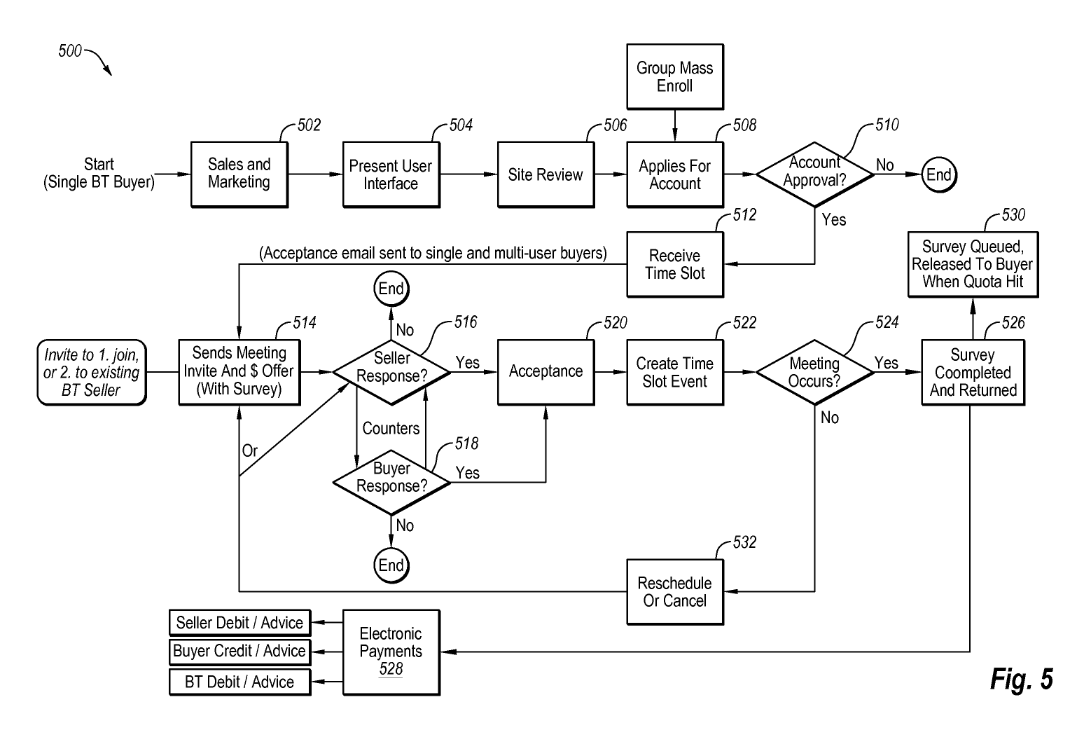

FIG. 5 is a flow diagram of one embodiment of a method 500 of buying time slot transactions. The method 500 is performed by processing logic that may comprise hardware (circuitry, dedicated logic, etc.), software (such as is run on a general-purpose computing system or a dedicated machine), or a combination of both. In one embodiment, the time slot manager 100 of FIG. 1 performs the method 500.

The method starts and the processing logic presents information at block 502 to a potential buyer intended to inform the potential buyer about the concept of time slot transactions, as described above. At block 504, the processing logic presents an online user interface (e.g., a website, mobile application) for the potential buyer to review (block 506), and the processing logic receives an application from the potential buyer (block 508). The processing logic determines if the account should be approved at block 510.

If the account is approved at block 510, the now approved buyer may begin time slot transactions. At block 512, the processing logic receives a time slot request from the approved buyer to initiate an event between the buyer and a seller during the time slot. The request can include information pertaining to the time slot request, which man include an identity of the buyer and a proposed consideration from the buyer for the seller, as described herein. For example, a user can create an offer by inputting the terms of the offer in one or more fields or selecting options from a menu of a user interface, such as a web interface, and can submit the input as the terms of the offer. The processing logic receives the offer submitted by the user.

At block 514, the processing logic can provide the time slot request of the buyer and information pertaining to the time slot request to the seller. The time slot request may include an identity of the buyer and the proposed consideration. In some embodiments, the time slot request from the buyer includes a message and an attachment. The message may include at least a portion of the information pertaining to the time slot event, and the attachment may include a document to be discussed between the buyer and the seller during the time slot event. In some embodiments, the processing logic provides a feedback form (e.g., survey) to the seller along with the time slot request. The feedback can include at least one feedback question (e.g., a predefined question) related to the time slot event. In some embodiments, the processing logic provides information related to the feedback form, and the feedback form is provided to the seller at a later date (e.g., after completion of the time slot event). The offer can be presented to the seller, such as via an email, a webpage, or the like. The processing logic can receive an answer from the seller at block 516. The answer from the seller can be an acceptance or a counterproposal. The counterproposal can include an alteration to at least one of the time slot items, including the proposed consideration. When the answer from the seller is a counterproposal, the processing logic can present the counterproposal to the buyer and receive a response from the buyer at block 518. The seller may accept or again counter propose. Any number of offers, counter offers, counter proposals, etc. are contemplated. Once the buyer and seller arrive at an agreement to the terms of the time slot event, processing logic can receive an acceptance from each the seller and the buyer at block 520. The processing logic creates a time slot event for the buyer and the seller at block 522. When creating the time slot event, the processing logic can coordinate a time slot event (e.g., meeting) between the buyer and seller. In one embodiment, coordinating a meeting includes managing communications, calendar events, etc. In some embodiments, the processing logic can provide information pertaining to the time slot event (e.g., time, location, date, topic) to the buyer and the seller. At block 524, the processing logic determines that the time slot event has occurred. The processing logic can receive an indication of a completion of the time slot event. For example, when the time slot event is complete, a user (buyer or seller) may provide input that indicates the time slot event is complete. The processing logic generates one or more feedback forms (e.g., surveys) and may provide or transmit the feedback form(s) to either the buyer or the seller, or both. Upon receiving the completed feedback form(s) at block 526, the processing logic may authorize and/or processes transfer of the consideration (e.g., compensation) to the buyer (e.g., electronic payments between the buyer and seller) at block 528. In some embodiment, the transfer of the consideration to the seller is contingent on an acceptance of the request by both the seller and the buyer, completion of the event, and the seller submitting the requested feedback (e.g., a completed feedback form).

At block 530, the processing logic may release the feedback results to the buyer. In some embodiments, the feedback results may be released to the buyer after a predetermined number of the same feedback form has been completed. In some embodiments, either the buyer or the seller may propose to reschedule or cancel the time slot event and the processing logic may receive such a proposal at block 532.

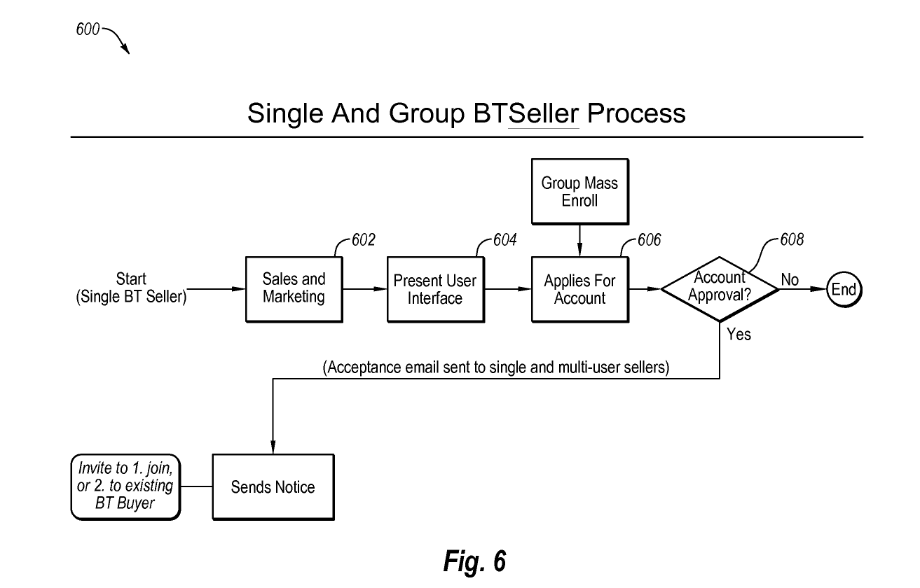

FIG. 6 is a flow diagram of one embodiment of a method 600 of soliciting and selling time slot transactions. The method 600 is performed by processing logic that may comprise hardware (circuitry, dedicated logic, etc.), software (such as is run on a general-purpose computing system or a dedicated machine), or a combination of both. In one embodiment, the time slot manager 100 of FIG. 1 performs the method 600.

In one embodiment, the method 600 starts, and the processing logic presents information to a potential seller intended to inform the potential seller about the concept of time slot transactions at block 602, as described above. The processing logic presents an online user interface for the potential seller to review at block 604, and the processing logic receives an application from the seller at block 606. The processing logic determines if the account should be approved at block 608. If the account is approved, the processing logic receives an offer from the seller to sell a time slot. Upon receiving an acceptance or counter offer from a buyer, the processing logic may perform any of the operations in blocks 516-532 described above with reference to FIG. 5.

FIG. 7 illustrates one embodiment of a seller dashboard 700, which may be generated by the dashboard manager 108 of FIG. 1. The depicted seller dashboard, 200 as customized by the dashboard manager 108, includes information related to time slots offered to be sold. Examples of information to be presented or requested from a seller include, but are not limited to:

### Seller Dashboard

### Confirmed Time Slot

### Name of Buyer

Name of Buyer company

### Time Slot Date

### Time Slot Time

### Time Slot Location

### Time Slot Confirmed fee

Time Slot Copy of feedback form used
Feedback form completed—y or n

The seller dashboard 700 may include user information 702 to identify the user (e.g., the seller) that is currently logged in and has access to the seller dashboard 700. In some embodiments, a user (e.g., seller) can provide input via the seller dashboard 700 to manage time slot events. For example, a seller may view time slot events 706 (e.g., received or pending events that have not yet been accepted by the seller), scheduled/confirmed time slot events, countered time slot events, elapsed and/or declined time slot events and completed time slot events. In some embodiments, the user can activate (e.g., click) on an entry in any of the above areas of the seller dashboard 700 to obtain more information related to the corresponding time slot event. The seller dashboard 700 may also provide a mechanism (e.g., button, drop down menu) that a seller can use to change which time slot events 706 are presented. As illustrated, the seller dashboard 700 is configured to present time slot events 706 from “this week.” Any filter or sorting mechanism may be used. The seller dashboard 700 may provide a mechanism for creating a new time slot event 704 where the seller would act as a buyer, as described herein.

The dashboard may also include one or more activity feeds 708. A feed 708 may include a collection of activities related to the seller. For example, the feed 708 may include offers for time slot events from buyers, counter offers of the seller, confirmation of time slot event, and so forth. The feed 708 may be present feed items in any order. As illustrated, the feed 708 presents the feed items on chronological order, with the newest activity on top. The seller may configure the display of the feed by time, buyer, event status, etc.

The dashboard may also include a calendar 710 of time slot events. The calendar 710 can present one or more time slot events in chronological order, with the soonest time slot events on top and later time slot events below. The calendar 710 may be configurable to present all time slot events or a subset of events (e.g., by buyer, time, status, etc.)

The seller dashboard 700 may also include a user control panel 712. The user control panel 712 may include various components, such as a notification component, a help feature, a link to a settings menu and a logout component. The notification component may notify the seller of new activities associated with the seller. For example, the notification component may indicate to the seller of a new time slot offer, an acceptance of a counter proposal, when a payment for a completed time slot event is made, and the like. The notification component may also include a counter that updates for each new activity. For example, as illustrated, the counter is set to “0” which indicates that there are no new activities.

The seller dashboard 700 may also include a navigation pane 714 that provides the seller with quick access to various features, such as the dashboard, a new invitation page, an offers page, a surveys page and a financial page. The user can select any of the features in the navigation pane 714 to access the respective page. For example, when a seller selects the “Financial” feature on the navigation pane 714, a financial information page may be presented to the seller via a GUI.

The seller dashboard 700 can also include other various time slot event management tools. In some embodiments, the seller dashboard 700 can provide the seller with an option to counter a time slot event. In some embodiments, the seller dashboard 700 can include a mechanism for providing feedback and/or completing feedback forms. Once a seller and a buyer have conducted a time slot event, the buyer, or seller or both may provide input via a GUI that the time slot event has occurred. After the time slot event, the seller dashboard 700 may present the seller with an option to provide feedback. Once the seller has provided feedback in relation to the time slot event, a financial area of the dashboard (not shown) may be updated to reflect the compensation for the seller in relation to the completed time slot event. In some embodiments, the seller dashboard 700 can include a mechanism for accessing and analyzing time slot events and/or related feedback forms (e.g., surveys).

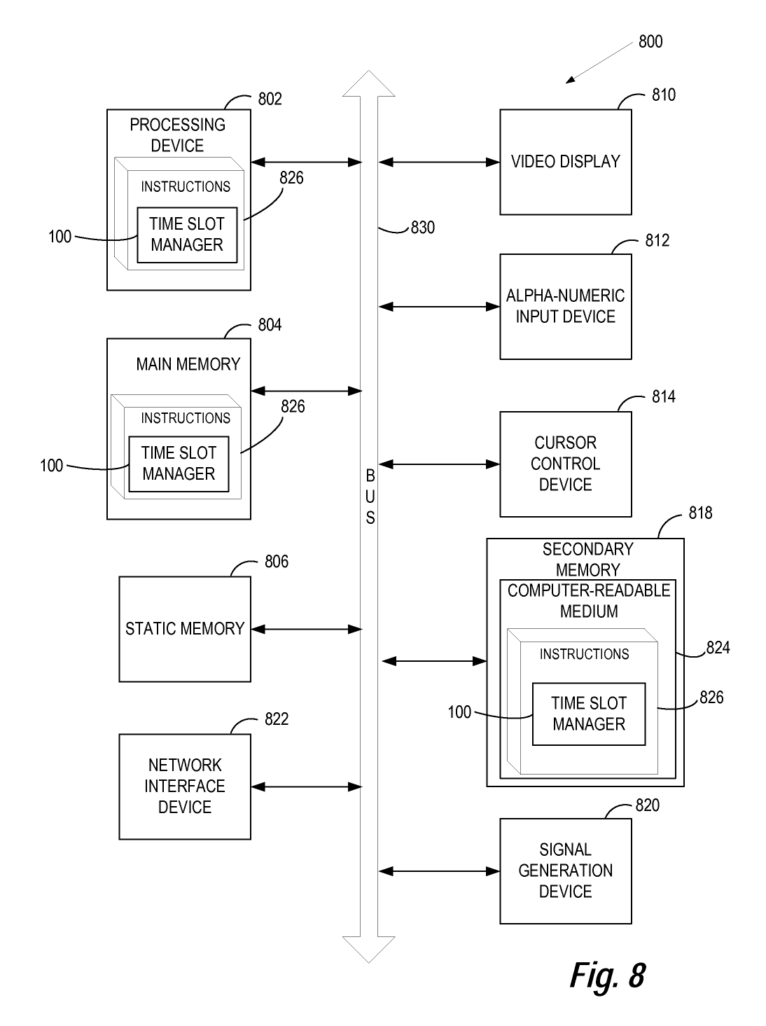

FIG. 8 is a block diagram illustrating an example computer system, according to some embodiments. Within the computer system 800 is a set of instructions for causing the machine to perform any one or more of the methodologies discussed herein. In alternative embodiments, the machine may be connected (e.g., networked) to other machines in a LAN, an intranet, an extranet, or the Internet. The machine can be a host in a cloud, a cloud provider system, a cloud controller or any other machine. The machine can operate in the capacity of a server or a client machine in a client-server network environment, or as a peer machine in a peer-to-peer (or distributed) network environment. The machine may be a personal computer (PC), a tablet PC, a console device or set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 800 includes a processing device 802, a main memory 804 (e.g., read-only memory (ROM), flash memory, dynamic random access memory (DRAM) such as synchronous DRAM (SDRAM) or DRAM (RDRAM), etc.), a static memory 806 (e.g., flash memory, static random access memory (SRAM), etc.), and a secondary memory 818 (e.g., a data storage device in the form of a drive unit, which may include fixed or removable computer-readable storage medium), which communicate with each other via a bus 830.

Processing device 802 represents one or more general-purpose processing devices such as a microprocessor, central processing unit, or the like. More particularly, the processing device 802 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 802 may also be one or more special-purpose processing devices such as an application specific integrated circuit (ASIC), a field programmable gate array (FPGA), a digital signal processor (DSP), network processor, or the like. Processing device 802 is configured to execute the instructions 826 for performing the operations and steps discussed herein.

The computer system 800 may further include a network interface device 822. The computer system 800 also may include a video display unit 810 (e.g., a liquid crystal display (LCD) or a cathode ray tube (CRT)) connected to the computer system through a graphics port and graphics chipset, an alphanumeric input device 812 (e.g., a keyboard), a cursor control device 814 (e.g., a mouse), and a signal generation device 820 (e.g., a speaker).

The secondary memory 818 may include a machine-readable storage medium (or more specifically a computer-readable storage medium) 824 on which is stored one or more sets of instructions 826 embodying any one or more of the methodologies or functions described herein. In one embodiment, the instructions 826 include instructions for the time slot manager 100. The instructions 826 may also reside, completely or at least partially, within the main memory 804 and/or within the processing device 802 during execution thereof by the computer system 800, the main memory 804 and the processing device 802 also constituting machine-readable storage media.

The computer-readable storage medium 824 may also be used to store the instructions 826 persistently. While the computer-readable storage medium 824 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing or encoding a set of instructions for execution by the machine and that cause the machine to perform any one or more of the methodologies of the present embodiments. The term “computer-readable storage medium” shall accordingly be taken to include, but not be limited to, solid-state memories, and optical and magnetic media.

The instructions 826, components and other features described herein can be implemented as discrete hardware components or integrated in the functionality of hardware components such as ASICS, FPGAs, DSPs or similar devices. In addition, the instructions 826 can be implemented as firmware or functional circuitry within hardware devices. Further, the instructions 826 can be implemented in any combination hardware devices and software components.

In the above description, numerous details are set forth. It will be apparent, however, to one skilled in the art, that the present embodiments may be practiced without these specific details. In some instances, well-known structures and devices are shown in block diagram form, rather than in detail, in order to avoid obscuring the present embodiments.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “providing,” “generating,” “transmitting,” “identifying,” “recording,” “accessing,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The present embodiments also relate to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The present embodiments may be provided as a computer program product, or software, that may include a machine-readable medium having stored thereon instructions, which may be used to program a computer system (or other electronic devices) to perform a process according to the present embodiments. A machine-readable medium includes any mechanism for storing or transmitting information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

Reference in the description to “one embodiment” or “an embodiment” means that a particular feature, structure, or characteristic described in connection with the embodiment is included in at least one embodiment of the invention. The phrase “in one embodiment” located in various places in this description does not necessarily refer to the same embodiment. Like reference numbers signify like elements throughout the description of the figures.

It is to be understood that the above description is intended to be illustrative, and not restrictive. Many other embodiments will be apparent to those of skill in the art upon reading and understanding the above description. Although the present embodiments have been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled.

1. A method comprising:
presenting a graphical user interface (GUI) over the Internet to a first computing device by a time slot manager executing on a processing device;
receiving, by the time slot manager, a time slot request via the GUI from a first entity at the first computing device to initiate an event between the first entity and a second entity at a second computing device, during the time slot, the request comprising a proposed consideration from the first entity for the second entity, the proposed consideration being specified by the first entity;
sending an electronic invitation, by the time slot manager over the Internet to the second entity at the second computing device, the electronic invitation comprising the time slot request of the first entity and information pertaining to the time slot request, and wherein the electronic invitation comprises an identity of the first entity and the proposed consideration;
receiving, by the time slot manager over the Internet from the second computing device, an electronic response to the electronic invitation, the electronic response comprising a first acceptance of the time slot request and the proposed consideration from the first entity and a second acceptance of the time slot request and the proposed consideration;
creating, by the time slot manager, a record in a database for a time slot event between the first entity and the second entity, wherein the time slot event digitally represents a scheduled meeting between the first entity and the second entity, wherein the record contains the proposed consideration, the identity of the first entity and payment information for the first entity, and an identity of the second entity and receipt of payment information for the second entity;
providing, by the time slot manager over the Internet, digital information pertaining to the time slot event to the first entity at the first computing device and the second entity at the second computing device;
receiving, by the time slot manager over the Internet, an first indication of a completion of the time slot event between the first entity and the second entity;
updating the record in the database for the time slot event with the first indication of the completion of the time slot event;
providing, by the time slot manager over the Internet, an electronic feedback form for the time slot event to the second entity, wherein, in exchange for the proposed consideration, the second entity is required to provide feedback related to the time slot event via the electronic feedback form;
receiving, by the time slot manager over the Internet, a response to the electronic feedback form from the second entity;
updating the record in the database for the time slot event with a second indication of completion of the electronic feedback form;
creating an authorization message when the record comprises the first indication of the completion of the time slot event and the second indication of completion of the electronic feedback form, the authorization message comprising the payment information for the first entity and the payment information for the second entity; and
sending, by the time slot manager over the Internet, the authorization message to a compensation payment provider with an instruction to send compensation related to the proposed consideration to the time slot manager, wherein the compensation payment provider is to send an electronic payment using the payment information for the first entity to the time slot manager;
remitting, by the time slot manager, the compensation related to the proposed consideration to the second entity using the payment information for the second entity; and
updating the record in the database for the time slot event with an indication that the agreed consideration has been settled between the first entity and the second entity.

2. The method of claim 1 further comprising receiving, by the time slot manager via the GUI, an electronic counterproposal to the time slot request from the second entity, the electronic counterproposal comprising an alteration to at least one of the time slot or the proposed consideration.

3. The method of claim 1, wherein the electronic feedback form comprises at least one feedback question related to the time slot event for the second entity from the first entity.

4. The method of claim 1, wherein the time slot request from the first entity comprises an electronic message and an electronic attachment, wherein the electronic message comprises at least a portion of the digital information pertaining to the time slot event, and wherein the electronic attachment comprises an electronic document to be discussed between the first entity and the second entity during the time slot event.

5. A method comprising:
presenting a graphical user interface (GUI) over the Internet to a first computing device by a time slot manager executing on a processing device;
receiving, by the processing device, a request from a first entity to initiate an event between the first entity at the first computing device and a second entity at a second computing device, the request comprising a time to conduct the event and a proposed consideration, the proposed consideration being specified by the first entity;
sending an electronic invitation, to the second entity at the second computing device over the Internet, an identity of the first entity, the time and the proposed consideration;
upon receiving an electronic acceptance of the time and proposed consideration from the second entity over the Internet from the second computing device, creating, by the time slot manager, a record in a database, the record containing the event between the first entity and the second entity, the proposed consideration and payment information to facilitate payment from the first entity to the second entity via the time slot manager, wherein the event digitally represents a scheduled meeting between the first entity and the second entity;
receiving, by the time slot manager, an indication of completion and electronic feedback over the Internet from the second entity from the second computing device pertaining to the event after the event, wherein in exchange for the proposed consideration, the second entity is required to provide the electronic feedback related to the event;
updating, by the time slot manager, the record in the database for the event with an indication of completion of the event and receipt of the electronic feedback;
creating an authorization message in response to receiving the indication of completion and the electronic feedback from the second entity; and
sending, by the time slot manager, the authorization message to a compensation payment provider with an instruction to electronically transfer payment for the proposed consideration to the time slot manager using the payment information in response to receiving the indication of completion and the electronic feedback from the second entity; and
remitting, by the time slot manager, the payment to the second entity.

6. The method of claim 5, wherein the creating the authorization message comprises determining, by the processing device, the following: the electronic acceptance has been received from the second entity, completion of the event, and the electronic feedback has been received from the second entity.

7. The method of claim 5 further comprising:
creating an electronic meeting invitation for the event that comprises the time of the event; and
providing the electronic meeting invitation to the first entity at the first computing device and the second entity at the second computing device.

8. The method of claim 5, wherein the request to initiate the event is received from the first entity via the GUI, wherein the identity of the first entity, the time and the proposed consideration is provided to the second entity via a second GUI.

9. The method of claim 8, wherein the GUI comprises an upload attachment tool, wherein the request from the first entity comprises an electronic attachment, wherein the electronic attachment is uploaded to a server via the upload attachment tool.

10. The method of claim 5 further comprising providing to at least one of the first entity or the second entity a GUI-based dashboard for tracking at least one time slot event and financial information related to the at least one time slot event.

11. The method of claim 5 further comprising
providing an electronic feedback form for the event to the second entity in response to the indication of the completion of the event.

12. The method of claim 11, wherein the electronic feedback form comprises a predefined set of questions to ask the second entity.

13. The method of claim 11, wherein the electronic feedback form comprises at least one feedback question related to the event for the second entity from the first entity.

14. (canceled)

15. A non-transitory computer-readable storage medium comprising instructions that, when executed by a processing device, cause the processing device to perform operations comprising:
presenting a graphical user interface (GUI) over the Internet to a first computing device by the processing device;
receiving, by the processing device, a request from a first entity at the first computing device to initiate an event between the first entity and a second entity at a second computing device, the request comprising a time to conduct the event and a proposed consideration, the proposed consideration being specified by the first entity;
sending an electronic invitation, to the second entity at the second computing device over the Internet, an identity of the first entity, the time and the proposed consideration;
upon receiving an electronic acceptance of the time and proposed consideration from the second entity over the Internet from the second computing device, creating, by the processing device, a record in a database, the record containing the event between the first entity and the second entity, the proposed consideration and payment information to facilitate payment from the first entity, via the time slot manager to the second entity, wherein the event digitally represents a scheduled meeting between the first entity and the second entity;
receiving an indication of completion and electronic feedback over the Internet from the second entity from the second computing device pertaining to the event after the event, wherein in exchange for the proposed consideration, the second entity is required to provide the electronic feedback related to the event;
updating the record in the database for the event with the indication of completion of the event and the electronic feedback;
creating an authorization message in response to receiving the indication of completion and the electronic feedback from the second entity; and
sending the authorization message to a compensation payment from the first entity provider with an instruction to electronically authorize payment for the proposed consideration using the payment information in response to receiving the indication of completion and the electronic feedback from the second entity.

16. The non-transitory computer-readable storage medium of claim 15, wherein the creating the authorization message comprises determining, by the processing device, the following: the electronic acceptance has been received from the second entity, completion of the event, and the electronic feedback has been received from the second entity.

17. The non-transitory computer-readable storage medium of claim 15, the operations further comprising:
creating an electronic meeting invitation for the event that comprises the time of the event; and
providing the electronic meeting invitation to the first entity at the first computing device and the second entity at the second computing device.

18. The non-transitory computer-readable storage medium of claim 15, the operations further comprising
providing an electronic feedback form for the event to the second entity in response to the indication of the completion of the event.

19. The non-transitory computer-readable storage medium of claim 15, wherein the request to initiate the event is received from the first entity via the GUI, wherein the identity of the first entity, the time and the proposed consideration is provided to the second entity via a second GUI.

20. The non-transitory computer-readable storage medium of claim 19, wherein the GUI comprises an upload attachment tool, wherein the request from the first entity comprises an electronic attachment, wherein the electronic attachment is uploaded to a server via the upload attachment tool.

21. The method of claim 11, wherein the indication of the completion of the event is received from either the first entity or the second entity.

22. The method of claim 1, further comprising:
creating and sending, by time slot manager, a first message to the first entity that the second entity has paid the proposed consideration in response to the third indication; and
creating and sending, by time slot manager, a second message to the second entity that the first entity has been paid the proposed consideration in response to the third indication.
